(19) United States
(12) Patent Application Publication
(10) Pub. No.: US 2022/0178392 A1
(43) Pub. Date: Jun. 9, 2022

(54) ENCLOSURE FASTENING MODULE

(71) Applicant: L-ACOUSTICS, WARCOUSSIS CEDEX (FR)

(72) Inventors: Christian HEIL, LONDON (GB); Christophe COMBET, Anthony (FR); Alex DERMU, VERSAILLES (FR)

(21) Appl. No.: 17/441,284

(22) PCT Filed: Mar. 20, 2020
(86) PCT No.: PCT/EP2020/057887

§ 371 Date: Sep. 20, 2021

(30) Foreign Application Priority Data
Mar. 29, 2019 (FR) 1903372

(51) Int. Cl. F16B 2/02

(52) U.S. Cl. CPC F16B 2/02

(57) ABSTRACT

A subject of the present invention is an enclosure fastening module, characterized in that the module comprises a longitudinal movable dowel, mounted on a dowel support, said dowel support being capable of moving both longitudinally and transversely relative to the module, said dowel being movable between a “locking” longitudinal position and an “unlocking” longitudinal position, the module further comprising a stop capable of longitudinally retaining the dowel support when it is in a first transverse position of its locking position and allowing a longitudinal movement of the dowel support when it is in a second transverse position of its locking position.

A subject of the present invention is an enclosure fastening module designed to be fastened to a fastening support outside the module such as, for example, an enclosure support or a fastening support belonging to another enclosure. A further subject of the invention is an enclosure provided with the fastening module and also a fastening assembly comprising said fastening module.

The enclosures are cabinets containing loudspeakers allowing the acoustic reproduction of sound. When installing a sound reinforcement system for an event, it is known to assemble enclosures together and to suspend them above the audience during the show in order to form clusters of enclosures that make it possible to optimize the radiated sound. A mechanical locking device is used for this structural assembling operation.

Once the show has ended, the clusters of enclosures are dismantled and usually moved between various storage locations. The locking system thus has to be easy to handle manually and to be tethered (non-separable).

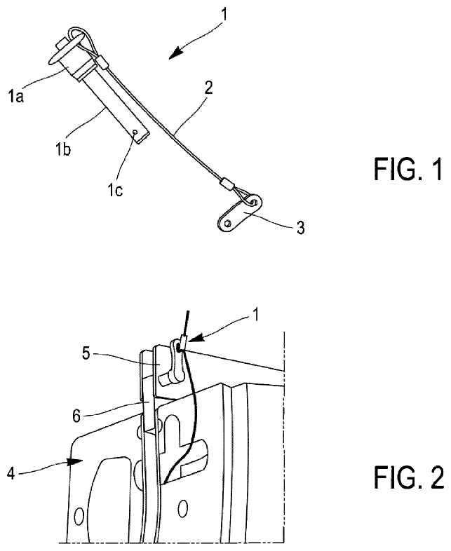

As illustrated in FIG. 1, a common solution is to use ball pins 1 connected to the enclosures by tethers 2 secured to a small plate 3. The ball pins provide mechanical locking and are easy to handle manually, and the tethers make it possible not to lose the device.

Mechanical locking is provided by the body 1b of the pin 1 itself, and secure mechanical locking is provided by a ball 1c that constitutes a stop. The ball 1c is able to retract through the action of a pushbutton 1a.

FIG. 2 illustrates the use of a ball pin 1 for fastening an enclosure 4 to an enclosure support 5. A rocker 6 secured to the enclosure is provided with a through-opening in which the body 1b of the pin 1 engages.

As enclosures regularly experience impacts in the course of the handling and storage phases, these locking devices of ball-pin-with-tether type are frequently damaged and/or lost. The pin heads may be broken, the tethers ruptured and the small plates may be torn away. In this case, the characteristics of the locking device may be partially or totally changed, rendering use of the enclosure impossible or even dangerous.

In response to this problem, an integrated locking device has been developed that cannot be torn away or damaged because it does not extend beyond the volume of the enclosure.

During operation, clusters of enclosure experience numerous vibrations. It is imperative that the mechanical locking device of the enclosures cannot be disengaged accidentally through the effect of these vibrations. As the enclosures are suspended above the audience, it is important to add an additional safety device to the enclosures, known as a “fail-safe”, so as to prevent any accidental fall, even in the event of failure of the securing device of the mechanical lock.

Known locking devices are not provided with such a fail-safe. Locking devices that use ball pins do not constitute a locking device integrated into the enclosure and are not provided with a fail-safe, whilst integrated locking devices likewise do not have this fail-safe.

The present invention aims to remedy these drawbacks.

A subject of the invention is thus an enclosure fastening module designed to be fastened to a fastening support outside the module.

The module according to the invention comprises a longitudinal movable dowel, mounted on a dowel support, said dowel support being capable of moving both longitudinally and transversely relative to the module, said dowel being designed to engage in an attachment element of the fastening support, said dowel being movable between a “locking” longitudinal position, in which the dowel is capable of being engaged in the attachment element of the fastening support, and an “unlocking” longitudinal position, in which the dowel is capable of being disengaged from the attachment element of the fastening support, the module further comprising a stop capable of longitudinally retaining the dowel support when it is in a first transverse position of its locking position and allowing a longitudinal movement of the dowel support when it is in a second transverse position of its locking position.

Thus, the module according to the invention constitutes a mechanical locking device by virtue of the movable dowel onto which an attachment element of a fastening support can attach. The module is, furthermore, easy to handle manually, integrated and tethered, since it can be integrated without difficulty into a housing in an enclosure and secured thereto. Lastly, the module according to the invention is provided with a fail-safe, owing to the presence of the stop that immobilizes the support, for example when subject to the vibrations from the enclosure. Indeed, in the event of failure of the securing of the lock, the movable dowel cannot be disengaged owing to the stop that immobilizes accidental translational movement. In order to overcome this stop, a supplementary action orthogonal to the translational movement of the movable dowel is required.

The dowel support may be arranged inside a module body, the stop being integrated into the module body.

Advantageously, the stop prevents longitudinal translational movement when switching from the locking position to the unlocking position and allows longitudinal translational movement when switching from the unlocking position to the locking position.

The stop may be thus be integrated into a transversely upper face of the module body and it may comprise a locking face orthogonal to the transversely upper face, the locking face being capable of longitudinally retaining the dowel support in the first transverse position of the dowel support, said locking face possibly being extended longitudinally by an unlocking face that is inclined relative to the transversely upper face and that connects the lower end of the locking face to the transversely upper face.

The dowel support is advantageously connected to the module body via at least one longitudinal return element, said at least one longitudinal return element being capable of holding the dowel support in its locking position.

The dowel support may comprise at least two longitudinal guides, each longitudinal guide comprising a longitudinal return element.

The dowel support may be connected to the module body via at least one transverse return element, said at least one transverse return element being capable of holding the dowel support in its first transverse position.

Said at least one transverse return element may be a ball spring plunger.

A further subject of the invention is an enclosure. The enclosure according to the invention comprises an above-described fastening module.

A further subject of the invention is a fastening assembly for an enclosure. The assembly according to the invention comprises an above-described fastening module and a fastening support outside the module.

The attachment element of the fastening support may comprise a pivoting rocker comprising an opening in which the movable dowel of the fastening module is designed to engage.

The fastening module may be secured to a first enclosure and the fastening support may be secured to a second enclosure.

Further advantages and particular features of the present invention will become apparent from the following description, which is given by way of non-limiting example and made with reference to the appended figures:

FIG. 1, already described, illustrates a first embodiment of a prior-art enclosure fastening device,

FIG. 2, already described, illustrates an enclosure fastened with the aid of the device of FIG. 1,

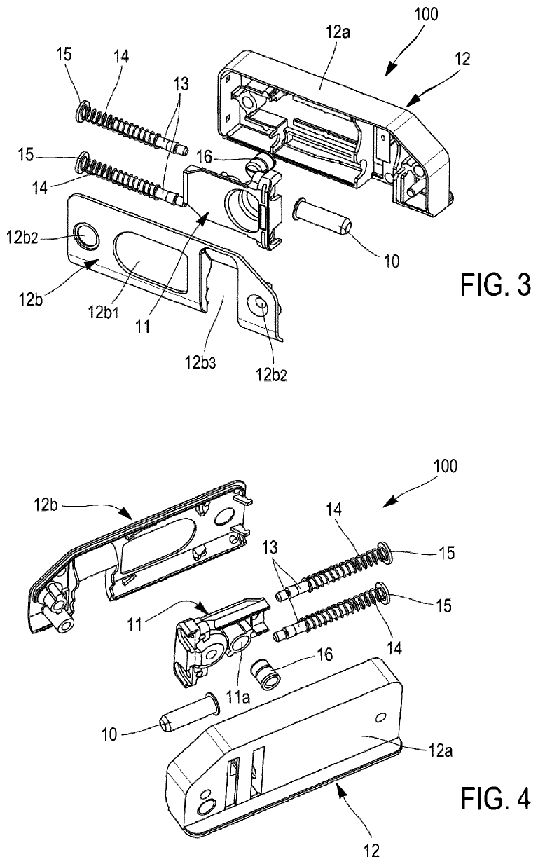

FIG. 3 is an expanded perspective front view of an enclosure fastening module according to the invention,

FIG. 4 is an expanded perspective rear view of an enclosure fastening module according to the invention,

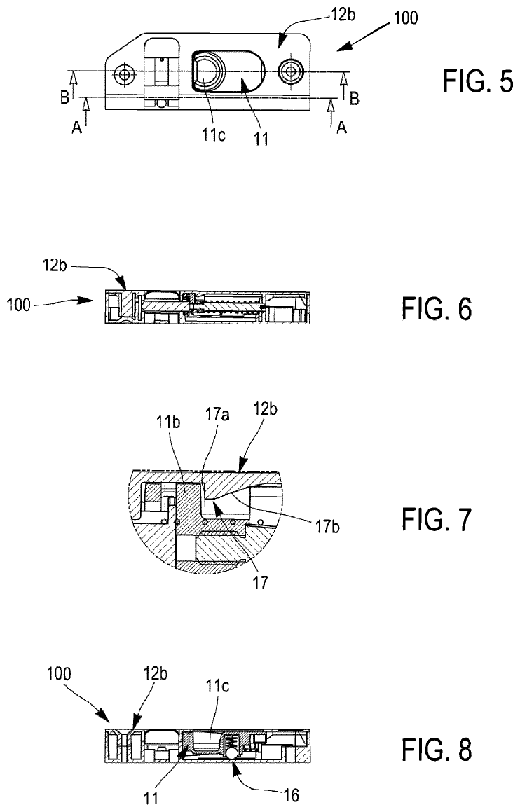

FIG. 5 is a top view of the fastening module according to the invention,

FIG. 6 is a first sectional view of the fastening module of FIG. 5,

FIG. 7 is a view of a detail of FIG. 6,

FIG. 8 is a second sectional view of the fastening module of FIG. 5,

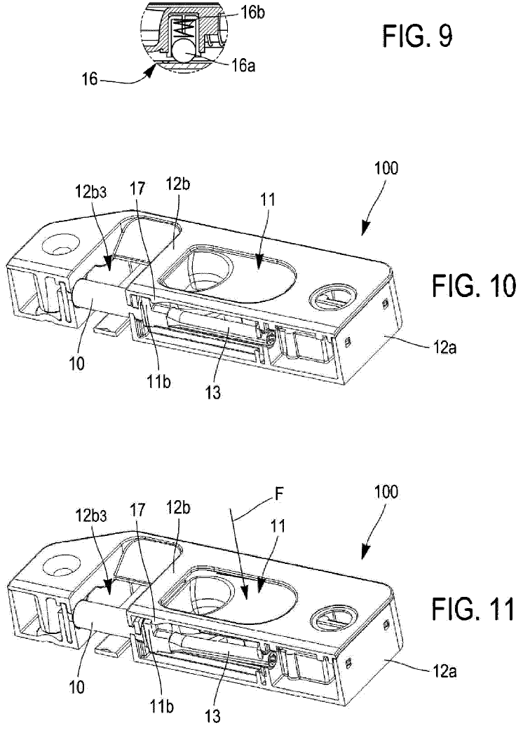

FIG. 9 is a view of a detail from FIG. 8,

FIGS. 10 to 14 illustrate, in perspective, different positions of the dowel support of the module upon switching from locking to unlocking of the module,

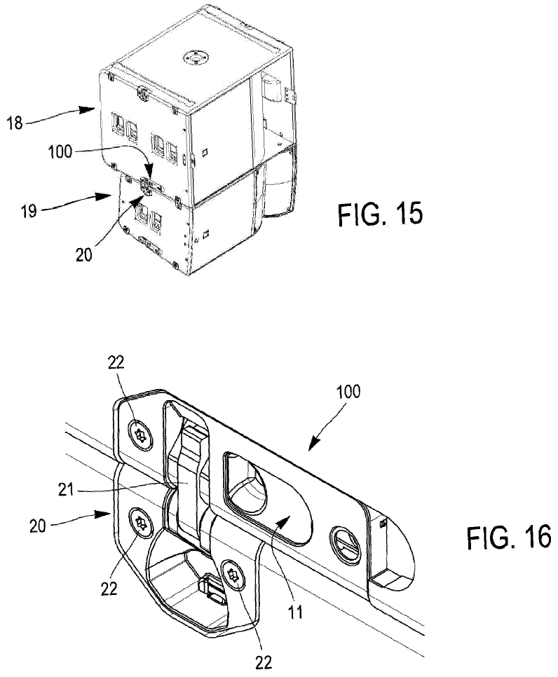

FIG. 15 is a perspective view of an assembly of two enclosures, one of which is provided with a fastening module according to the invention,

FIG. 16 is a view of a detail from FIG. 15, and

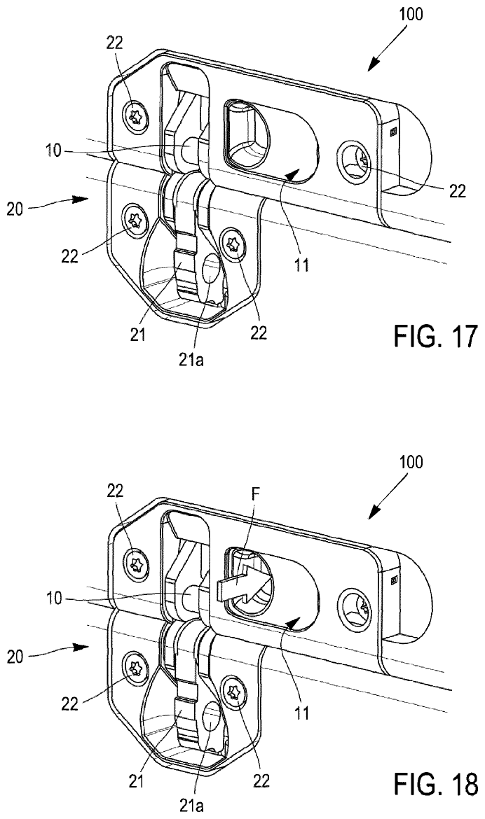

FIGS. 17 to 22 illustrate, in perspective, different configurations of the module according to the invention upon fastening a first enclosure to a second enclosure.

FIGS. 3 and 4 illustrate an enclosure fastening module 100 according to the invention. The fastening module 100, of elongate form, is designed to be fastened to a fastening support outside the module 100. The module 100 comprises a longitudinal movable dowel 10 that is mounted on a dowel support 11, also known as a pull device. The movable dowel 10 is designed to engage in an attachment element of the fastening support. The pull device 11, meanwhile, is arranged inside a module body 12. The module body 12 comprises a base 12a and a cover 12b. The cover 12b comprises a first orifice 12b1 enabling a user to gain access to the pull device 11, and also second orifices 12b2 allowing the passage of a screw for fastening the cover 12b to the base 12a. A third orifice 12b3 delimits the actual fastening zone in which the movable dowel 10 can engage in an attachment element of the fastening support.

The pull device 11 is capable of moving longitudinally relative to the module body 12, with the aid of two longitudinal guides 13. Each longitudinal guide 13 is connected to the base 12a of the module body 12 by a spring 14. The springs 14 terminate in a flat washer 15 that makes it possible to position the springs 12 on the base 12a of the module body 12 and act as a longitudinal stop for each longitudinal guide 13.

The pull device 11 is also capable of moving transversely relative to the module body 12. To that end, a transverse return element 16, such as a ball spring plunger, forms the link between the base 12a and the pull device 11. A housing 11a formed in the pull device 11 makes it possible to receive the ball spring plunger 16.

FIG. 5 illustrates the enclosure fastening module 100 in a top view.

As illustrated in FIG. 6, which is a sectional view A-A of FIG. 5, and in FIG. 7, the cover 12b of the module body 12 is provided with a projecting element 17 that constitutes a stop for the pull device 11. The stop 17 comprises a locking face 17a orthogonal to the upper face of the cover 12b. The locking face 17a extends transversely and is designed to retain the pull device 11 longitudinally and in particular a longitudinal locking element 11b that extends transversely, in a first transversely upper position of the pull device 11. If the pull device 11 is moved transversely downward, the locking element 11b will reach the lower end of the locking face 17a and it will no longer be retained longitudinally.

The locking face 17a is thus extended longitudinally by an unlocking face 17b that is inclined relative to the upper face of the cover 12b and that connects the lower end of the locking face to the upper face of the cover 12b (FIG. 7).

FIG. 8, which is a sectional view B-B of FIG. 5, and also FIG. 9 show, in particular, the ball spring plunger 16 that makes it possible to hold the pull device 11 in its transversely upper position, against the cover 12b, in the absence of a transverse force exerted downward on the pull device 11. The plunger 16 comprises a ball 16a and a spring 16b. Furthermore, a cavity 11c formed in the pull device 11 enables a user to move the pull device 11 both transversely and longitudinally by inserting a finger into the cavity 11c.

The remainder of the description is devoted to the way in which the fastening module, just described, operates.

As illustrated in FIG. 10, the movable dowel 10 of the pull device 11 is in its longitudinal locking position. In effect, the movable dowel 10 is fully engaged in the fastening zone 12b3, which it traverses entirely. The movable dowel 10 may thus engage in an opening of an attachment element of a fastening support outside the module 100. In this position, the locking element 11b of the pull device 11 bears longitudinally against the stop 17 of the module body 12 and, more precisely, bears against the vertical locking face 17a (FIG. 7). The locking element 11b may be a rib that engages in a corresponding groove (channel) of the cover 12b. The vertical face 17a constitutes a transverse face of this groove. The transverse return element that constitutes the ball spring plunger 16 (FIG. 8) holds the pull device 11 and, in particular, the locking element 11b in a first transverse position, which is a transversely upper position, against the cover 12b.

If it is desired to progress to an unlocking position of the movable dowel 10, i.e. if it is desired to slide the movable dowel 10 towards the right in the figure, the user exerts a downward transverse force F on the pull device 11 (FIG. 11), which gives rise to a vertical downward movement of the pull device 11. The pull device 11 then reaches a second transverse position, when the transversely upper end of the locking element 11b reaches the lower end of the stop 17 which is the lower end of the vertical locking face 17a.

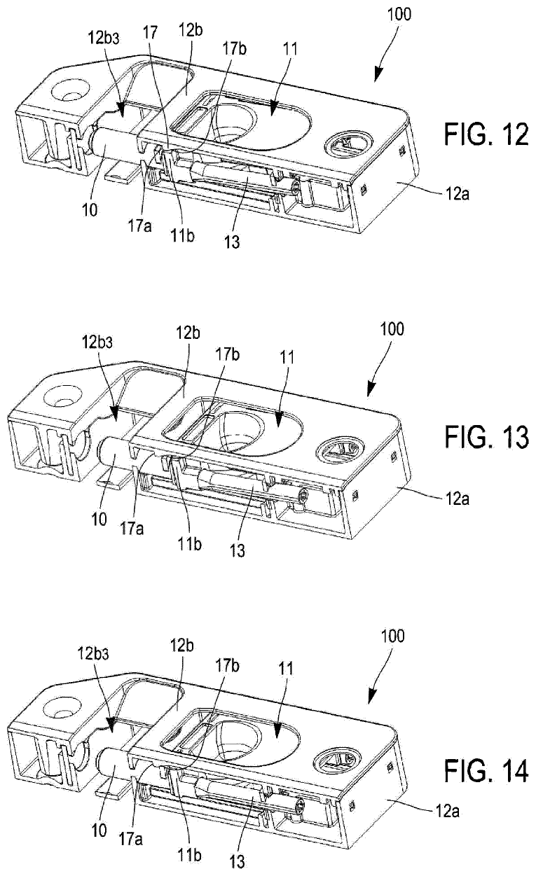

Through the action of the user, the pull device 11 and thus the movable dowel 10 will move longitudinally toward the right from this second transverse position. FIG. 12 shows the start of the passage of the locking element 11b under the unlocking face 17b of the stop 17. FIG. 13 shows, meanwhile, the end of the passage of the locking element 11a under the unlocking face 17b. The longitudinal movement of the movable dowel 10 then continues, and the ball spring plunger 16 holds the locking element against the cover 12b (FIG. 14).

FIG. 15 illustrates an assembly of two enclosures 18,19, namely an upper enclosure 18 and a lower enclosure 19. The upper enclosure 18 is provided with a fastening module 100 according to the invention. The module 100 is, for example, embedded in a housing along a lower edge of the enclosure 18. The module 100 may be fastened to the upper enclosure 19 with the aid of screws 22.

The module 100 is designed to be fastened to a fastening support 20 outside the enclosure 18. This fastening support may be an enclosure support or a fastening support belonging to another enclosure. FIG. 16 illustrates the case when the fastening support 20 belongs to a lower enclosure 19. The fastening support 20 may be fastened to the lower enclosure 19 with the aid of screws 22. The fastening support 20 is provided with an attachment element in which the movable dowel 10 of the fastening module 100 is able to engage. The attachment element may be a rocker 21 comprising a longitudinal opening 21a in which the movable dowel 10 is able to engage (FIG. 17). The rocker 21 is mounted such as to pivot on an axis parallel to the movable dowel 10 of the fastening module 100.

As illustrated in FIG. 16, the movable dowel of the module 100 is in its locking position. The movable dowel is thus engaged inside the opening in the rocker 21 and the two enclosures 18,19 are fastened to one another.

In order to achieve this locking, the starting point is a configuration in which the movable dowel 10 is in its natural, locking position, the movable dowel 10 not being engaged in the rocker 21 (FIG. 17). In a first step, a transverse action on the pull device 11 illustrated by the arrow F causes the pull device 11 to switch from its first transverse position to its second transverse position, in which the pull device 11 is disengaged from the stop 17 (FIG. 18).

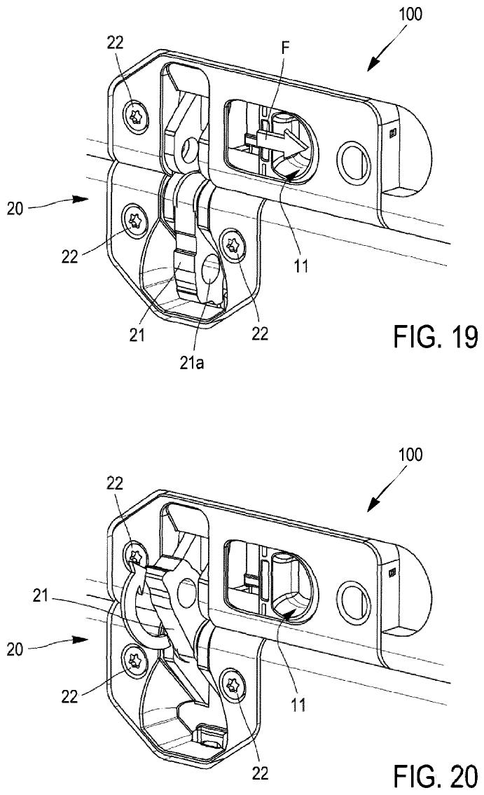

Once the pull device 11 is no longer retained longitudinally by the stop 17, it is possible to move the pull device 11 longitudinally towards the right of the figure, by inserting a finger in the cavity 11b and by moving the finger in the direction indicated by the arrow F (FIG. 19).

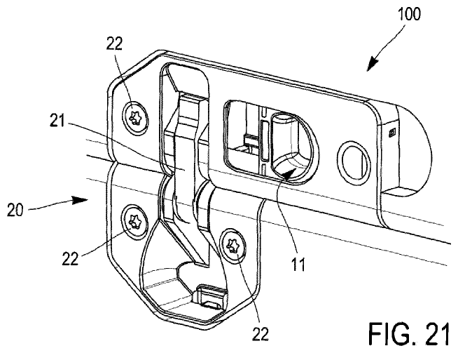

When the movable dowel 10 has reached its longitudinal unlocking position, the rocker 21 is rotated in such a manner that the opening 21a in the rocker 21 is aligned with the movable dowel 10 (FIGS. 20 and 21).

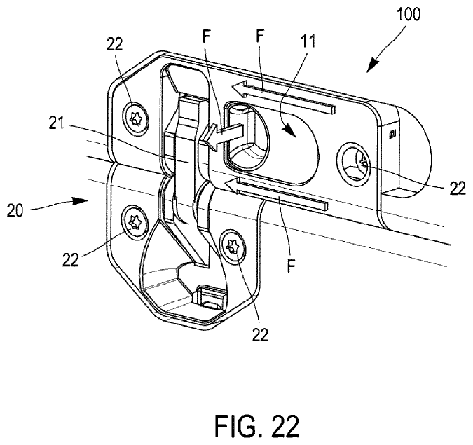

As illustrated in FIG. 22, the process ends upon release of the pull device 11, and the pull device 11 and the movable dowel 10 will return naturally to their longitudinal locking position and in the first transverse position of the pull device 11 through the action of the springs 14 and of the ball spring plunger 16 (FIGS. 3 and 4), in the directions indicated by the arrows F. The movable dowel 10 traverses the through-orifice 21a in the rocker 21 entirely, which fastens the upper enclosure 18 to a lower enclosure 19.

1. Enclosure fastening module, designed to be fastened to a fastening support outside the module, characterized in that the module comprises a longitudinal movable dowel, mounted on a dowel support, said dowel support being capable of moving both longitudinally and transversely relative to the module, said dowel being designed to engage in an attachment element of the fastening support, said dowel being movable between a “locking” longitudinal position, in which the dowel is capable of being engaged in the attachment element of the fastening support, and an “unlocking” longitudinal position, in which the dowel is capable of being disengaged from the attachment element of the fastening support, the module further comprising a stop capable of longitudinally retaining the dowel support when it is in a first transverse position of its locking position and allowing a longitudinal movement of the dowel support when it is in a second transverse position of its locking position.

2. Fastening module according to claim 1, characterized in that the dowel support is arranged inside a module body, the stop being integrated into the module body.

3. Fastening module according to claim 2, characterized in that the stop is integrated into a transversely upper face of the module body and in that it comprises a locking face orthogonal to the transversely upper face, the locking face being capable of longitudinally retaining the dowel support in the first transverse position of the dowel support, said locking face being extended longitudinally by an unlocking face that is inclined relative to the transversely upper face and that connects the lower end of the locking face to the transversely upper face.

4. Fastening module according to claim 1, characterized in that the dowel support is connected to the module body via at least one longitudinal return element, said at least one longitudinal return element being capable of holding the dowel support in its locking position.

5. Fastening module according to claim 4, characterized in that the dowel support comprises at least two longitudinal guides, each longitudinal guide comprising a longitudinal return element.

6. Fastening module according to claim 1, characterized in that the dowel support is connected to the module body via at least one transverse return element, said at least one transverse return element being capable of holding the dowel support in its first transverse position.

7. Fastening module according to claim 6, characterized in that said at least one transverse return element is a ball spring plunger.

8. Enclosure, characterized in that it comprises a fastening module according to claim 1.

9. Enclosure fastening assembly, characterized in that it comprises a fastening module according to claim 1 and a fastening support outside the module.

10. Assembly according to claim 9, characterized in that the attachment element of the fastening support comprises a pivoting rocker comprising an opening in which the movable dowel of the fastening module is designed to engage.

11. Assembly according to claim 9, characterized in that the fastening module is secured to a first enclosure and in that the fastening support is secured to a second enclosure.
